(19) United States
(12) Patent Application Publication
(10) Pub. No.: US 2006/0076817 A1
(43) Pub. Date: Apr. 13, 2006

(54) Movement limiter, particularly for pivotable elements of a vehicle seat

(75) Inventor: Walter Link, Leverkusen (DE)

Correspondence Address: FOLEY & LARDNER LLP, 777 EAST WISCONSIN AVENUE, SUITE 3800, MILWAUKEE, WI, 53202-5308, US

(73) Assignee: JOHNSON CONTROLS TECHNOLOGY COMPANY, HOLLAND MI 49423, MI (US)

(21) Appl. No.: 10/532,192

(22) PCT Filed: Oct. 17, 2003
(86) PCT No.: PCT/EP03/11533

§ 371 Date: Apr. 21, 2005

(51) Int. Cl. B60N 2/02

(52) U.S. Cl. 297/378.14

(57) ABSTRACT

Disclosed is a device for limiting the movement of rotatably mounted parts, especially pivotable upholstery elements of vehicle seats (1). Said device comprises a locking piece (7) which is disposed inside the rotatably mounted part and can be made to releasably engage with a thrust bearing (15). The inventive locking piece (7) effectively cooperates with a control device (10) that is located in the area of the joint (4) of the rotatably mounted part.

### CROSS-REFERENCE TO RELATED PATENT APPLICATIONS

This application is the National Stage of International Application No. PCT/EP2003/011533, filed Oct. 17, 2003 and claims benefit to German Application No. 10249100.3, filed Oct. 21, 2002, both of which are incorporated herein by this reference.

### FIELD

The invention relates to a device for limiting the movement of rotatably mounted parts, in particular pivotable upholstery elements of vehicle seats, having a locking piece which is arranged inside the rotatably mounted part and which can be made to releasably engage with a counter-bearing, and to correspondingly equipped vehicle seats.

### BACKGROUND

A device of the generic type is disclosed by the published patent application DE 44 35 835 A1. The rear seat unit for a motor vehicle described therein is equipped with a vertically divided backrest, the backrest segments of which are rotatably mounted in the transition to the seat part and independently of one another can be folded forwards from an upright position of use into a horizontal transport position.

Since cargo situated in the luggage space can strike the rear side of the upright backrest in the event of a frontal impact, and can expose this to considerable forces, in the event of an accident the backrest segments can be bolted together by means of a bolt horizontally displaceable transversely to the direction of travel. If cargo strikes one backrest segment, not only is the rotational movement of the latter limited by lateral locking on the body side, but the forces are also dissipated by way of said bolt to the body-side locking of the other backrest segment. This limiting of movement improves the safety of the vehicle occupants.

The bolt is displaced by means of a spring energy accumulator or a pyrotechnic charge, which is activated by a deceleration sensor responding to a high rate of vehicle deceleration.

Such systems are technically expensive and in addition harbor certain dangers for the vehicle occupants due to the high bolt speeds.

Thus there is a need to provide a movement-limiting device which is reversible and which affords a conspicuously simple design construction.

### SUMMARY OF THE INVENTION

There is provided a locking piece that operatively interacts with a control device situated in the area of the joint of the rotatably mounted part of a vehicle seat.

The operative interaction is preferably achieved by means for the mechanical transmission of force, in particular by a Bowden cable. It is also feasible, however, to use a connecting rod linkage or a hydraulic device for this purpose.

The locking piece advantageously comprises a bolt, preferably arranged so that it is longitudinally displaceable in the rotatably mounted part, the bolt being extendable from one of the end faces of the part, for example, but being fully retracted into the part when not in use. This improves not only the visual appearance of the locking device but also the occupant safety.

In order to bring the bolt automatically into engagement with the counter-bearing, the latter may have an inclined and/or arched end face. In this case the bolt, even in the operative position, can preferably be pushed into the part against the action of a spring, so that as it strikes the counter-bearing it recoils, but then engages in an undercut section of the counter-bearing.

One embodiment of the device for limiting movement includes a control device that has a mechanical guide, in relation to which the rotatably mounted part is angularly adjustable. The mechanical guide may comprise a control cam, a guideway or an eccentric disc, for example.

It is of particular advantage if the counter-bearing acts as limit stop in one direction of rotation of the rotatably mounted part, and as releasable catch device in the opposite direction of rotation. Thus, for example, an upholstery part of a vehicle seat can be pivoted right into a limit position, in which it is safeguarded against forcible overturning. Overturning might occur, for example, under the effect of loading in the event of an accident or it might be caused by misuse. On the other hand it can easily be pivoted back as soon as a predefined release force is exceeded.

There is also provided a vehicle seat having at least one rotatably mounted upholstery element, the movement of which is limited by a device previously described. In such a vehicle seat, for example, the movement of a from a substantially upright position onto the seat part is limited. It is furthermore possible to use the limiting device in the context of a vehicle seat having a seat part that can be folded from a substantially horizontal position of use away from the backrest into a vertical or horizontal transport position. The device can equally well be designed so as to limit the movement between segments of the backrest that can be folded from substantially upright positions of use onto the seat part into horizontal transport positions.

### BRIEF DESCRIPTION OF THE DRAWINGS

The drawings represent various exemplary embodiments of a vehicle seat and a device for limiting movement of a rotably mounted part in schematic form.

FIG. 1 shows a side view of a first vehicle seat equipped with an exemplary embodiment of a device for limiting movement in a position of use.

FIG. 2 shows the vehicle seat according to FIG. 1 in a transport position

FIG. 3 shows an enlargement of the locking piece used in the vehicle seat according to FIGS. 1 and 2 in an extended position

FIG. 4 shows the locking piece according to FIG. 3 in a retracted condition

FIG. 5 shows a control device, suitable for use in the arrangement, in two operative positions

FIG. 6 shows an exemplary embodiment of a vehicle seat equipped in a position of use including an exemplary embodiment of a device for limiting movement.

FIG. 7 shows the vehicle seat according to FIG. 6 in a transport position

FIG. 8 shows a front view of an exemplary embodiment of a bench seat with divided backrest and a locking of the backrest segments including a device for limiting movement.

FIG. 9 shows an enlarged section X-X from FIG. 8

FIG. 10 shows a control device for the bench seat according to FIG. 8

FIG. 11 shows another exemplary embodiment of a vehicle seat equipped including an exemplary embodiment of a device for limiting movement in a position of use

FIG. 12 shows the vehicle seat according to FIG. 11 in a transport position.

### DETAILED DESCRIPTION OF THE PREFERRED EMBODIMENTS

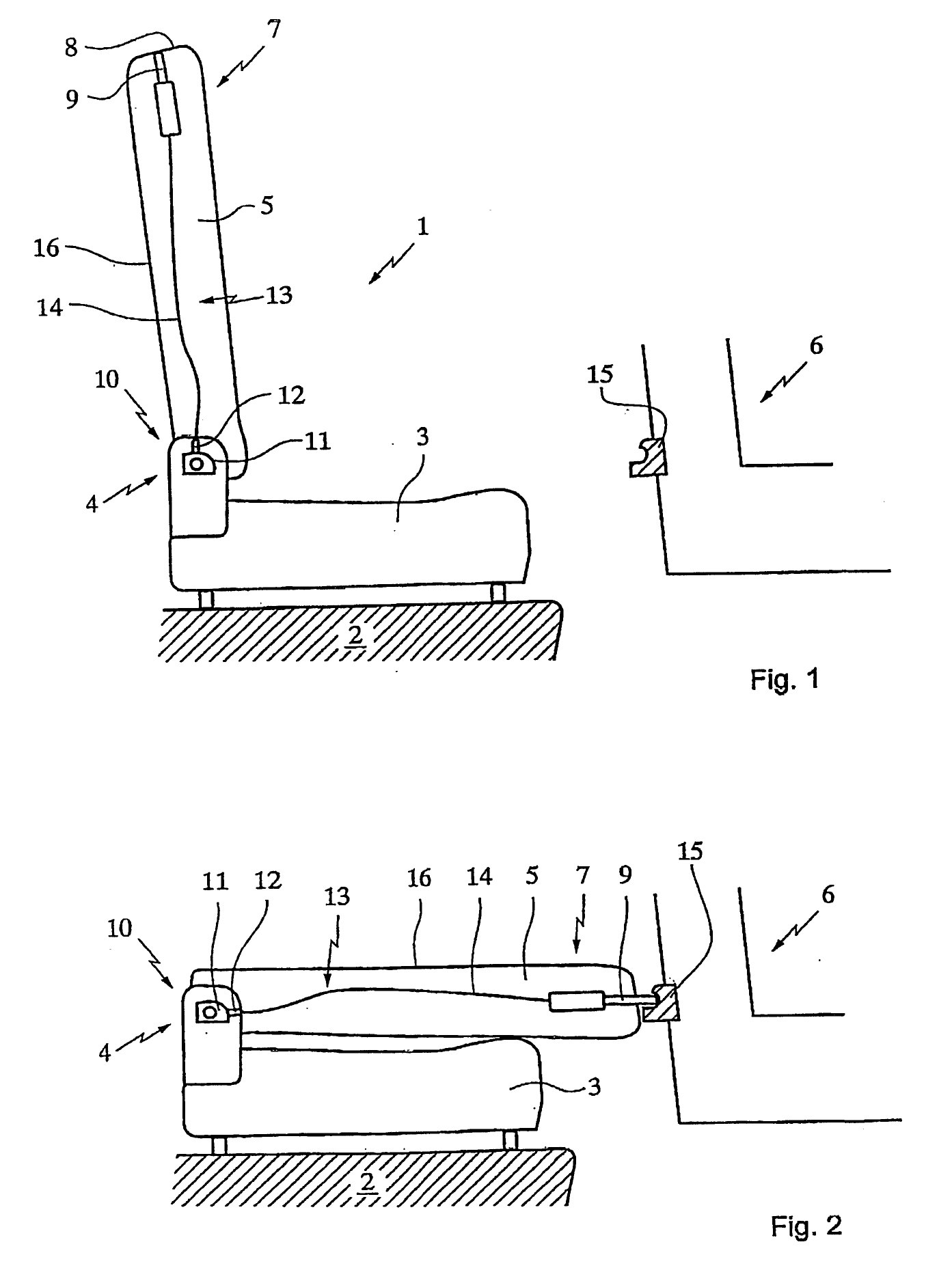

The vehicle seat 1 shown in FIGS. 1 and 2 comprises a seat part 3 connected to the vehicle floor 2, and a backrest 5 rotatably connected thereto in the area of a joint 4. The backrest 5 can be folded from a substantially upright position of use (FIG. 1) in the direction of another vehicle seat 6 arranged in front of this into a horizontal transport position (FIG. 2).

The vehicle seat 1 with a movement limiting device is provided in the area of the backrest 5 remote from the joint with a locking piece 7, provided with a bolt 9 that can be pushed out of the upper end face 8 of the backrest 5. A control device 10 comprising a control cam 11 and a feeler 12 is arranged in the area of the joint 4. The feeler 12 and the bolt 9 operatively interact by way of a mechanical force-transmitting device 13 in the form of a Bowden cable 14 in such a way that the feeler 12, which is pressed in by the control cam 11 when the backrest 5 is folded forwards, pushes the bolt 9, connected to the other end of the Bowden cable 14, forwards above the end face 8.

As can be seen from FIG. 2, the bolt 9 can now be releasably latched in a counter-bearing 15 situated on the rear of the other vehicle seat 6. This serves, on the one hand, to present a predefined resistance to the return of the backrest 5, and on the other to prevent any forcible overturning of the backrest 5 due to overloading of the rear side 16.

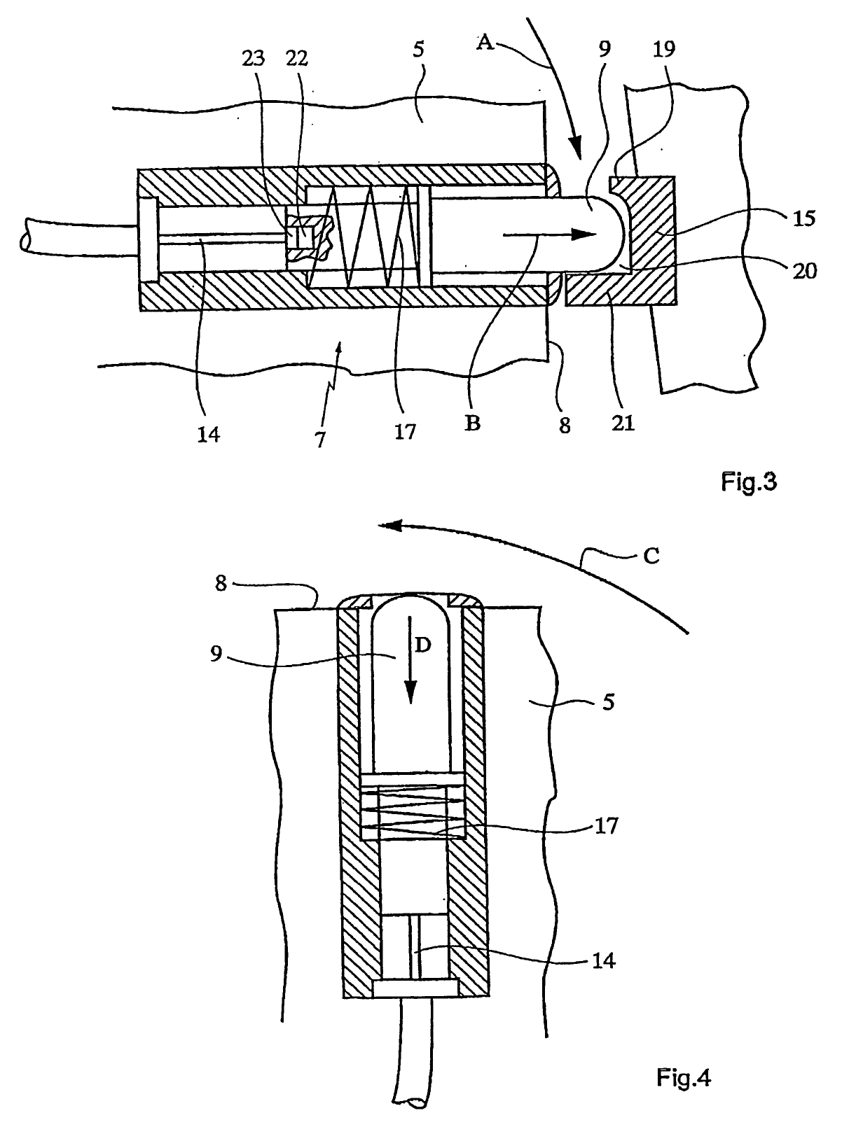

The locking piece 7 depicted in FIGS. 3 and 4 comprises the bolt 9 which, when the backrest 5 is folded forwards (arrow A) into the transport position, is pushed out of the backrest 5 (arrow B) by the Bowden cable 14 assisted by a compression spring 17 and then protrudes from its end face 8. The bolt 9 is naturally withdrawn against the resistance of the compression spring 17. As it engages in the counter-bearing 15, the bolt 9, rounded with a domed shape at its projecting end, overcomes a first projection 19 integrally formed thereon, which is relatively short and which is passed over as the bolt 9 recoils when the backrest 5 is folded in the direction of the arrow A. The bolt 9 springing back into its projecting position then lies in a recess 20 on a further, more salient projection 21 of the counter-bearing 15, which can no longer be overcome, even under high load, and which serves as limit stop for the rotational movement of the backrest 5.

During the brief compression the bolt 9, due to a cavity 22 which is let into the latter and in which the end piece 23 of the Bowden cable 14 can move, can be displaced in relation thereto, so that there is no reaction on the control device 10.

When the backrest 5 is folded back into the position of use (arrow C), the bolt 9 is first disengaged from the recess 20 under renewed compression and is then retracted into the backrest 5 (arrow D) until its domed end is aligned approximately flush with the end face 8. In this position it is largely invisible and does not adversely affect the handing of the vehicle seat 1.

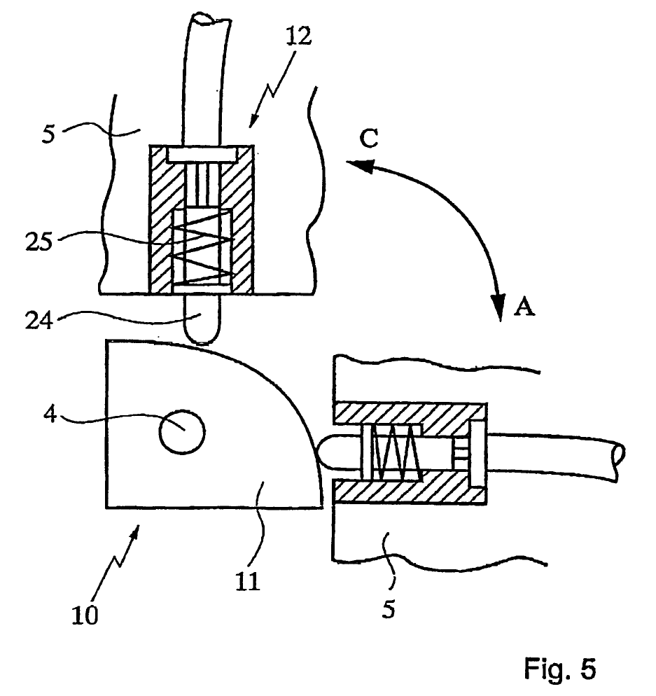

The locking piece 7 is mechanically connected by way of the Bowden cable 14 to the control device 10 shown in FIG. 5, which comprises a control cam 11 fixed to the seat part and a feeler 12 pivoting with the backrest 5. The feeler 12 has a pin 24, which is pressed onto the contour of the control cam 11 by means of a compression spring 25. The compression spring 25 must obviously have a greater stiffness than the compression spring 17 acting in the locking piece 7, which is essentially intended to permit releasable engagement of the bolt 9 in the counter-bearing 15. The pin 24 is pushed in as it runs over the contour of the control cam (forwards folding of the backrest 5, arrow A), the bolt 9 being pushed out by the Bowden cable 14, or forced back out by the compression spring 25 when the bolt 9 is retracted (rearwards folding of the backrest, arrow C).

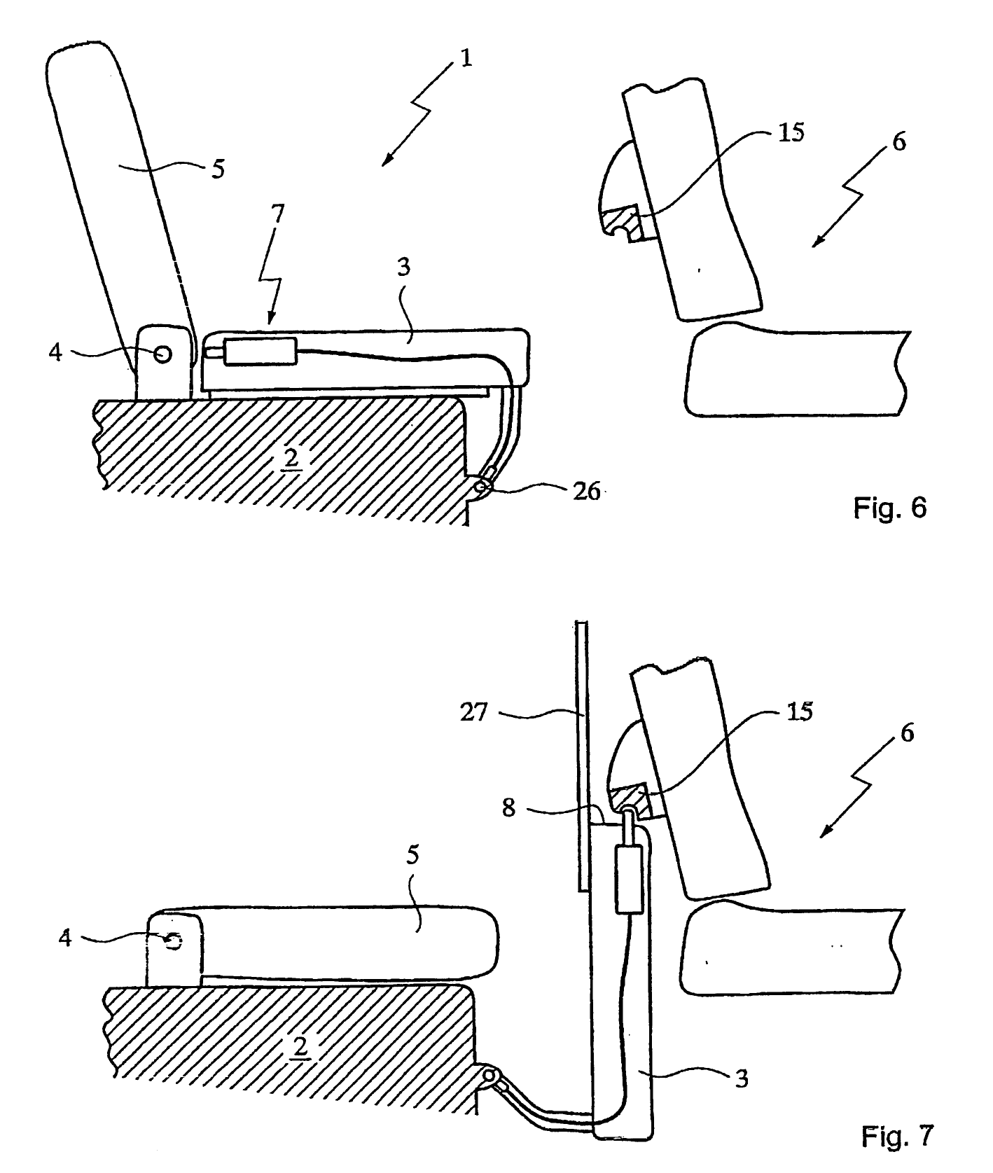

In the vehicle seat according to FIGS. 6 and 7 both the backrest 5 and also the seat part 3 are folded from a position of use (FIG. 6) into a transport position (FIG. 7). For this purpose the seat part 3, on its side remote from the backrest, is rotatably connected by means of a further joint 26 to the vehicle floor 2, and can be pivoted from the horizontal position into a vertical position, in which it bears, for instance, on the other vehicle seat arranged in front of it. The backrest of the vehicle seat 1 can then be pivoted forwards into a horizontal position.

In order to protect the front vehicle seat 6 from cargo striking it in the event of an accident, a protective plate 27 can be drawn out of the seat part pivoted into the vertical position. The forces acting thereon are dissipated via the joint 26 and a locking piece 7 arranged in the seat part, connected to a counter-bearing 15, into the vehicle floor 2 and/or the front vehicle seat 6. The locking piece 7 is arranged in the area of the seat part 3 facing the backrest and is provided with a bolt 9 which can be run out of the relevant end face 8 and which also engages in the counter-bearing 15 as soon as the seat part is situated in a vertical position.

The locking piece 7 and counter-bearing 15 correspond in function and construction to the embodiment previously described.

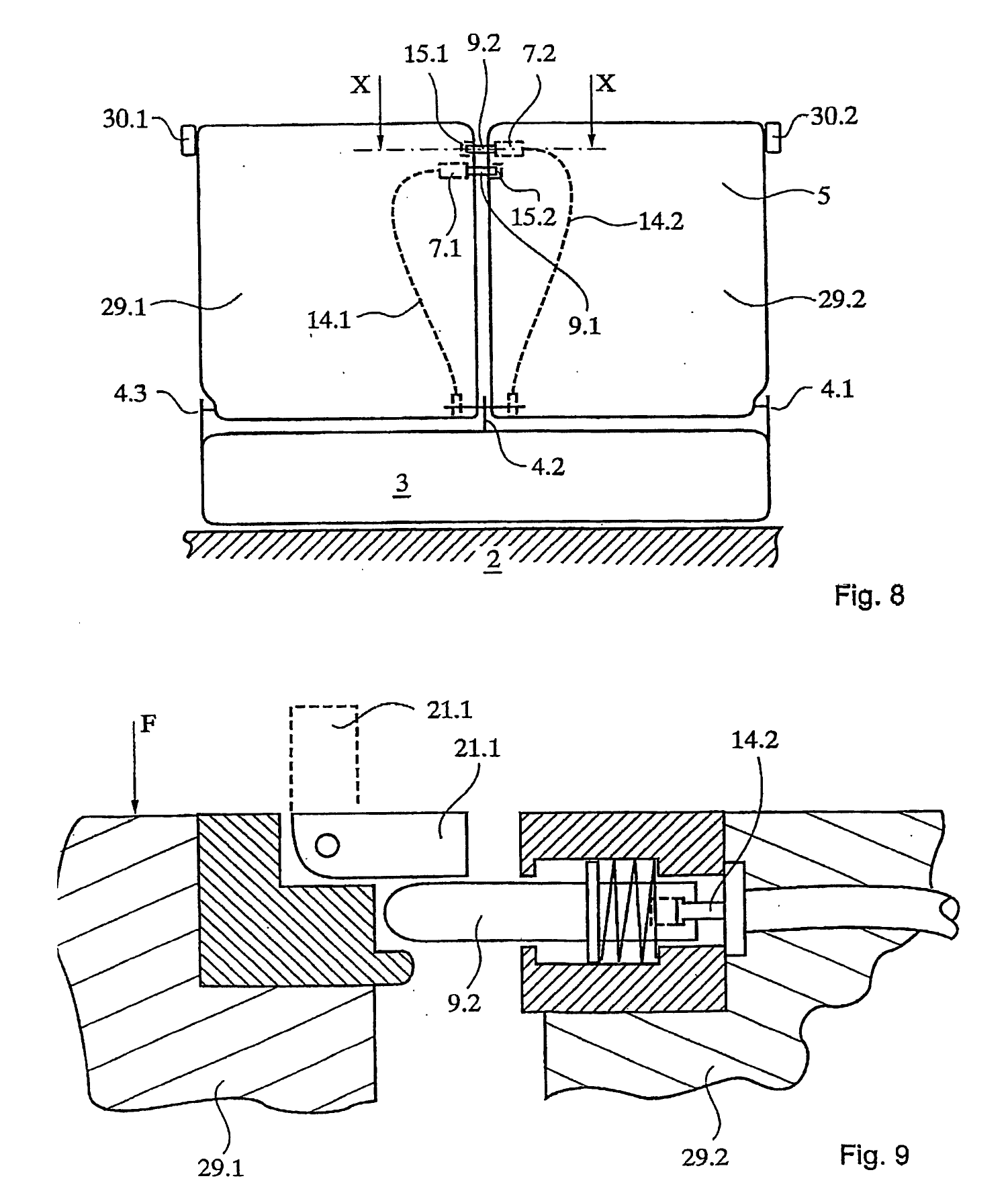

A vehicle bench seat 28 equipped with an exemplary embodiment of a movement limiting device and having a divided backrest 5 is depicted in FIG. 8. The backrest 5 is divided into backrest segments 29.1, 29.2, which independently of one another can be pivoted forwards by means of joints 4.1 to 4.3 onto the seat part 3.

In order to dissipate overloads, which in the event of an accident act upon the rear side of a backrest segment 29.1, 29.2, through the entire backrest 5, the segments 29.1 and 29.2 in their upright position of use can be interconnected by way of two locking pieces 7.1, 7.2, one of which is arranged in each backrest segment 29.1 and 29.2 and which engages in a counter-bearing 15.2, 15.1 in the other backrest segment 29.2, 29.1. In a departure from the embodiments previously described, bolts 9.1, 9.2 of the locking pieces 7.1, 7.2 are in this case actuated so that they are run out in the position of use but are retracted when folding over into the transport position and do not impede a passenger sitting next to the folded backrest segment 29.

As can be seen from FIG. 9, at the occurrence of a force F acting on the backrest segment 29.1 this is supported by way of the longer projection 29.1 on the bolt 9.2 of the other backrest segment. Should the force act on the other backrest segment 29.2, the force is transmitted by way of the laterally inverted locking piece 7.1. Both backrest segments 29.1, 29.2 are in turn connected by way of lateral arresting mechanisms 30.1, 30.2 to the vehicle body. The movement limiting device therefore serves to distribute any force acting off-center to both of the arresting mechanisms 30.1 and 30.2.

The locking pieces 7.1, 7.2 are actuated by way of two control devices 10.1, 10.2 arranged in the area of the middle joint 4.2 and connected to Bowden cables 14.1 and 14.2.

In order to be able to fold the backrest segment 29.1 forward separately, the projection 21.1 designed to rotate in the counter bearing 15.1 must be temporarily pivoted backwards by means of an actuating device (not shown). The other backrest segment 29.2 is similarly released by an actuation of the counter-bearing 15.2. The articulated support for the projections 21.1 and 21.2 must obviously be provided with a releasable locking which is capable of withstanding the loads in the event of an accident.

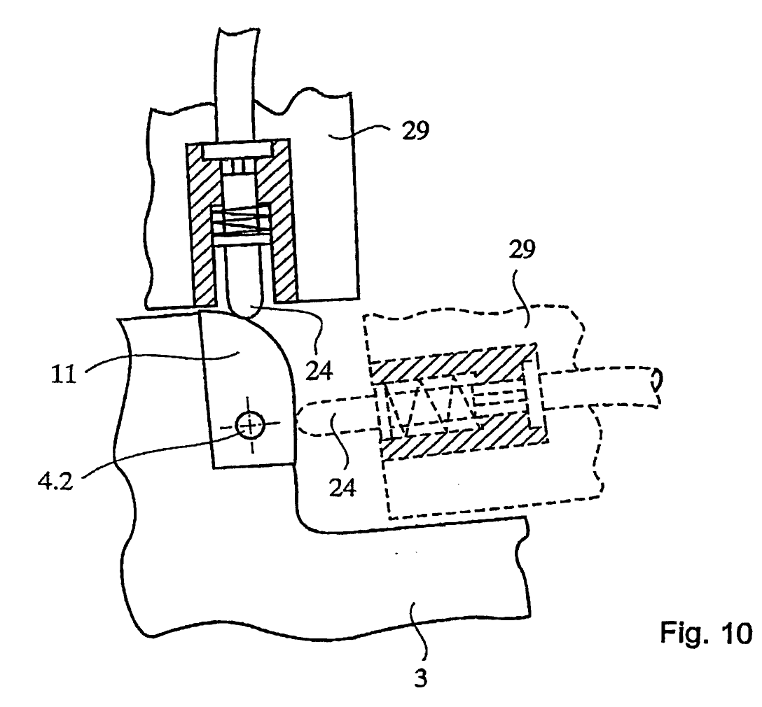

As shown in FIG. 10, the control devices 10 are in principle of similar design construction to the embodiments previously represented. The control cams 11 are designed, however, so that the pin 24 is pushed in when the backrest 5 is in the upright position and the bolt 9 is consequently run out.

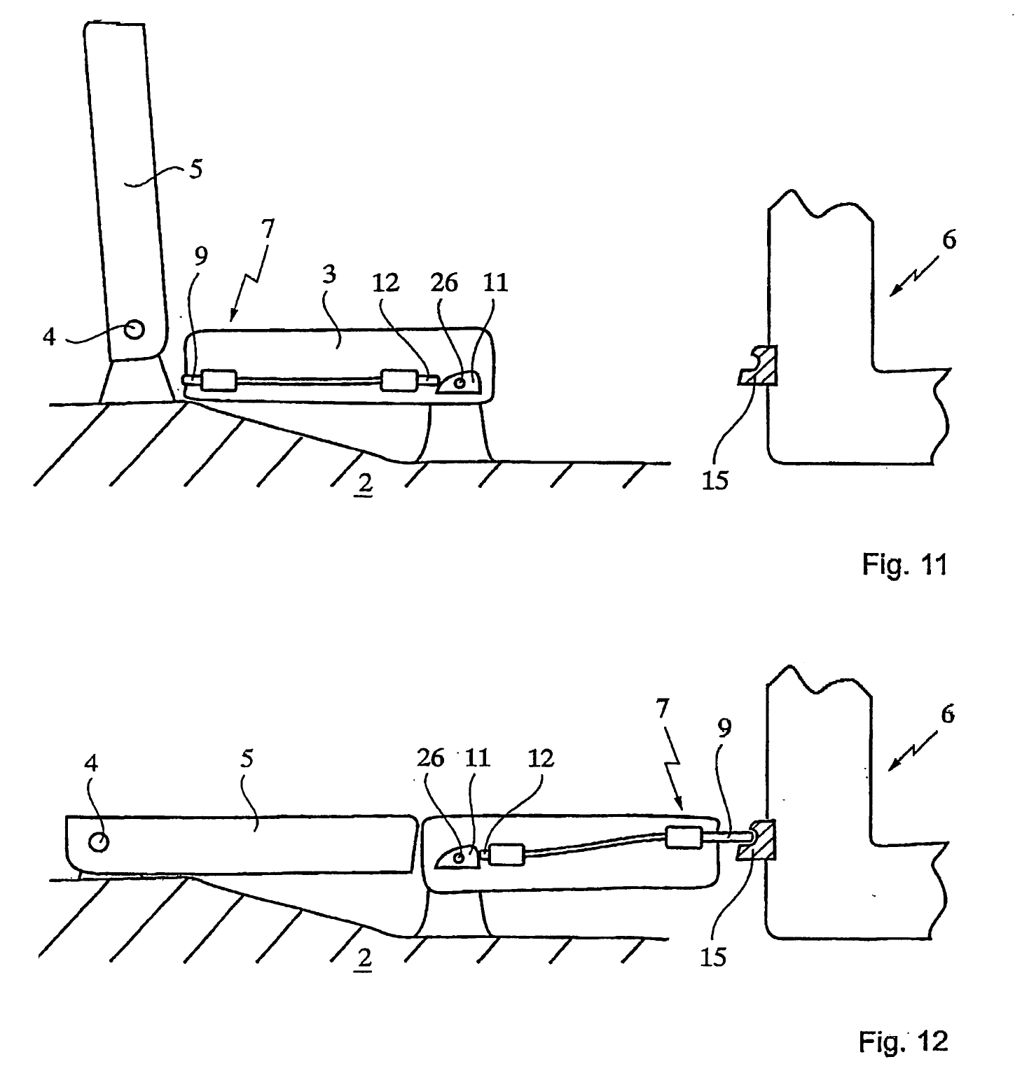

The vehicle seat according to FIGS. 11 and 12 largely corresponds to the embodiment according to FIGS. 6 and 7, but in contrast to this the seat part 3 in the joint 26 can be folded approximately 180° forwards into a horizontal transport position, thereby increasing the load floor considerably.

What is claimed is:

1. A device for limiting the movement of at least one rotatably mounted part, in particular a pivotable upholstery element of a vehicle seat (1), the device comprising: a locking piece (7) which is arranged inside the rotatably mounted part and can be made to releasably engage with a counter-bearing (15), wherein the locking piece (7) operatively interacts with a control device (10) situated in the area of the joint (4) of the rotatably mounted part.

2. The device as claimed in claim 1, wherein the operative interaction occurs by way of a mechanical force-transmitting device (13).

3. The device as claimed in claim 1, wherein the locking piece (7) comprises a bolt (9) configured to longitudinally displace in the rotatably mounted part.

4. The device as claimed in claim 3, wherein the bolt (9) is configured with one of an inclined and arched end face.

5. The device as claimed in claim 4, wherein the bolt (9) is configured to be pushed into the part against the action of a compression spring (17).

6. The device as claimed in claim 1 wherein the control device (10) includes a mechanical guide configured to angularly adjust the movement of the rotatably mounted part.

7. The device as claimed claim 1, wherein the counter-bearing (15) acts as a limit stop in one direction of rotation of the rotatably mounted part, and as releasable catch device in the opposite direction of rotation.

8. A vehicle seat (1) comprising:
at least one rotatably mounted upholstery element;
and a device limiting the movement of the upholstery element, the device comprising:
a locking piece (7) which is arranged inside the rotatably mounted part and can be made to releasably engage with a counter-bearing (15), wherein the locking piece (7) operatively interacts with a control device (10) situated in the area of the joint (4) of the rotatably mounted part.

9. The vehicle seat as claimed in claim 8, wherein the device is configured to limit the movement of a backrest (5) folded from a substantially upright position of use onto a seat part (3) into a horizontal transport position.

10. The vehicle seat as claimed in claim 8, wherein the device serves to limit the movement of the seat part (3) folded from a substantially horizontal position of use away from the upholstery element into one of a vertical and horizontal transport position.

11. The vehicle seat as claimed in claim 8, wherein the device serves for limiting the movement between segments (29.1, 29.2) of the upholstery element that can be folded from substantially upright positions of use onto the seat part (3) into horizontal transport positions.
